(19) United States
(12) Patent Application Publication
(10) Pub. No.: US 2008/0000094 A1
(43) Pub. Date: Jan. 3, 2008

(54) Pencil sharpener with a small limitation

(76) Inventor: Guanghui Tong, Ningbo (CN)

Correspondence Address: Kenneth Cole, 3979 Amberley Lane, Marietta, GA, 30062, US

(21) Appl. No.: 11/478,720

(22) Filed: Jul. 3, 2006

(51) Int. Cl. B43L 23/00

(52) U.S. Cl. 30/457; 30/454

(57) ABSTRACT

A pencil sharpener with a small limitation having a blade module having at least one conical channel for receiving an end of a pencil that needs to be sharpened and a cutting blade fixed alongside the conical channel with a screw. A small limitation is formed on the blade module at a thinner end of each conical channel and alongside the cutting blade for stopping further insertion of the pencil along the conical channel when a lead of said pencil is sharpened to a predetermined length.

### BACKGROUND OF THE INVENTION

1. Field of the Invention

The invention relates to stationery, more particularly, to a pencil sharpener with a small limitation.

2. Description of the Prior Art

Pencil sharpener usually has a blade module having a conical channel for receiving an end of a pencil that needs to be sharpened and a blade fixed alongside the conical channel with a screw. Some pencil sharpeners also have a housing enveloping the blade module for collecting paring.

Pencil sharpeners having a soft core blocking limitation have long been developed. The limitations are used to stop the soft core lead when the pencil is sharpened. When soft core of the pencil is sharpened to a predetermined length, a tip of the soft core is blocked by the limitation and then a user is able to know that sharpening is complete. These sharpeners have a number of advantages. For example, they are able to decrease waste. The user is able to stop sharpening when soft core of the pencil has just been sharpened to a needed length. Soft core breakings in sharpening are always caused by continuing sharpening actions when the sharpened soft core is long enough.

A pencil sharpener having a pencil limiting device is disclosed in a U.S. Pat. No. 6,427,343. In this invention, a pencil sharpener includes a casing secured in a housing and having a groove for receiving a pencil to be sharpened and having a cutter blade for sharpening the pencil. A device has a slide slidably received in the housing and has an extension extended from a resilient arm and engaged into the groove of the casing for determining the engagement of the pencil into the groove of the casing and for controlling the sharpening operation of the pencil. The slide may be adjusted relative to the housing for adjusting the engagement of the extension into the casing.

Another sharpener is disclosed in Chinese patent CN87207266U by Zhou Yihua In this invention, a limiting plate 4 is fixed onto a blade module by a screw. In yet another Chinese patent ZL98230020.4, owned and invented by Tang, Dongyun, a blocking plate is integrally formed on a blade module to stop further insertion of a pencil when a lead of the pencil is sharpened to a predetermined length.

However, all three aforementioned sharpeners have a common drawback: their structure is relatively complex. The sharpener of the U.S. patent takes a long time in manufacturing and is easy to be out of work due to its complex design. Tang's sharpener is much better but it still uses much more material in forming the blocking plate. Zhou's sharpener needs time to install the limiting plate onto the blade module.

### BRIEF SUMMARY OF THE INVENTION

The main object of the invention is to provide a pencil sharpener with a small limitation which is able to stop further insertion of the pencil when a lead of the pencil is sharpened to a predetermined length, and which meanwhile uses less material in manufacturing the sharpener.

Another object of the invention is to provide a pencil sharpener with a small limitation which is able to stop further insertion of the pencil when the lead of the pencil is sharpened to a predetermined length, and which at the same time is simple in structure and thus easy to be manufactured.

In accordance with one aspect of the invention, there is provided a pencil sharpener with a small limitation having a blade module having at least one conical channel for receiving an end of a pencil that needs to be sharpened and a cutting blade fixed alongside the conical channel with a screw. A small limitation is formed on the blade module at a thinner end of each conical channel and alongside the cutting blade for stopping further insertion of the pencil along the conical channel when a lead of said pencil is sharpened to a predetermined length.

### BRIEF DESCRIPTION OF THE DRAWINGS

FIG. 1 is a perspective view of a preferred embodiment of the invention.

FIG. 2 is a top view of the embodiment shown in FIG. 1.

FIG. 3 is a cross-sectional view along line A-A of FIG. 2. And,

FIG. 4 is a top view of another preferred embodiment of the invention.

### DETAILED DESCRIPTION OF THE PREFERRED EMBODIMENTS

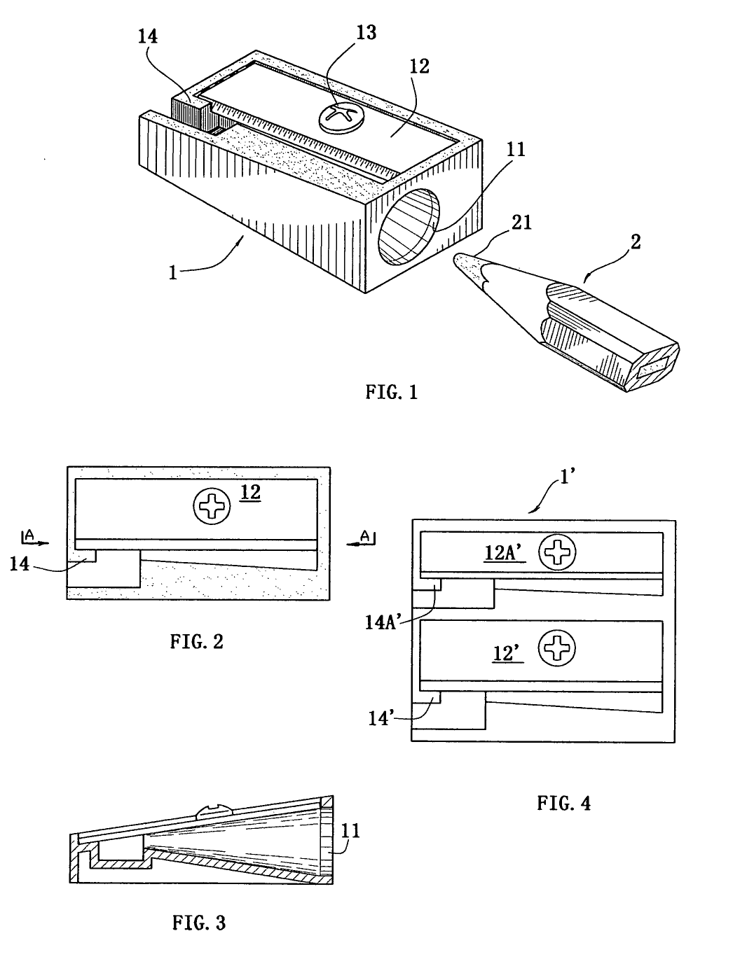

As shown in FIGS. 1, 2, and 3, a preferred embodiment of a pencil sharpener of the invention has a blade module 1 having at least one conical channel 11 for receiving an end of a pencil 2 that needs to be sharpened and a cutting blade 12 fixed alongside the conical channel 11 with a screw 13. In this embodiment, the blade module 1 has one conical channel 11. A small limitation 14 is formed on the blade module 1 at a thinner end of the conical channel 11 and alongside the cutting blade 12 for stopping further insertion of the pencil 2 along the conical channel 11 when a lead 21 of the pencil 2 is sharpened to a predetermined length.

It could be seen that compared with the blocking plate of the prior art, the small limitation of the invention uses much less material but is also able to stop further insertion of the pencil 2 along the conical channel 11 when a lead 21 of the pencil 2 is sharpened to a predetermined length. Meanwhile, the small limitation 14 makes the structure of the sharpener of the invention very simple and neat to manufacture.

Shown in FIG. 4 is another preferred embodiment of the invention. The blade module 1′ of the sharpener has two conical channels for respectively receiving an end of a pencil. A small limitation 14′, 14A′ is formed on the blade module 1′ at a thinner end of each conical channel and alongside the cutting blade 12′, 12A′ for stopping further insertion of the pencil 2′ along each conical channel when a lead of the pencil is sharpened to a predetermined length. The two conical channels may have different diameters for receiving ends of pencils of different diameters. They also may have a same diameter. At this time, one small limitation 14′ is formed further along the cutting blade 12′ than another small limitation 14A′, in order that the sharpener is able to sharpen leads of different length.

The pencil sharpener of the invention may also have a housing enveloping the blade module for collecting paring.

What is claimed is:

1. A pencil sharpener with a small limitation comprising:
a blade module having at least one conical channel for receiving an end of a pencil that needs to be sharpened and a cutting blade fixed alongside said conical channel with a screw; and,
a small limitation formed on said blade module at a thinner end of each said conical channel and alongside said cutting blade for stopping further insertion of said pencil along said conical channel when a lead of said pencil is sharpened to a predetermined length.

2. A pencil sharpener with a small limitation as claimed in claim 1, wherein said blade module has two conical channels.

3. A pencil sharpener with a small limitation as claimed in claim 2, wherein said two conical channels have different diameters for respectively receiving pencils of different diameters.

4. A pencil sharpener with a small limitation as claimed in claim 2, wherein said two conical channels have a same diameter but one said small limitation is formed further along said cutting blade than another said small limitation, in order that said sharpener is able to sharpen said leads of different length.

5. A pencil sharpener with a small limitation as claimed in claim 1, wherein said sharpener has a housing enveloping said blade module for collecting paring.

6. A pencil sharpener with a small limitation as claimed in claim 2, wherein said sharpener has a housing enveloping said blade module for collecting paring.

7. A pencil sharpener with a small limitation as claimed in claim 3, wherein said sharpener has a housing enveloping said blade module for collecting paring.

8. A pencil sharpener with a small limitation as claimed in claim 4, wherein said sharpener has a housing enveloping said blade module for collecting paring.
